(19) United States
(12) Patent Application Publication
(10) Pub. No.: US 2010/0129181 A1
(43) Pub. Date: May 27, 2010

(54) LENS HANDLER

(76) Inventors: Joseph D. Blasiak, Fairport, NY (US); Travis M. Fisher, Webster, NY (US)

Correspondence Address: Bausch & Lomb Incorporated, One Bausch & Lomb Place, Rochester, NY, 14604-2701, US

(21) Appl. No.: 12/275,240

(22) Filed: Nov. 21, 2008

(51) Int. Cl. B25J 15/08; B25J 13/00

(52) U.S. Cl. 414/4; 414/800

(57) ABSTRACT

A lens handler includes a first arm and a second arm, the first and second arms of the lens handler being moveable relative to each other to define an open position, a closed position, and a lens handling position. The lens handler also includes a power source electrically connected to the first and second arms and configured to pass an electrical current between the first and second arms when the arms are in the closed position.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### FIELD OF THE INVENTION

This invention relates generally to an apparatus for transporting optical parts such as contact lenses and more particularly to an apparatus for picking up contact lenses and reliably determining whether a lens has been successfully picked up.

### DESCRIPTION OF RELATED ART

In the automatic manufacture and packaging of contact lenses, it is necessary, at various stages of the manufacturing, to pick up a contact lens and move it to another location. For example, during manufacture, individual, wet, contact lenses may be moved from their respective trays into an inspection cell. While devices for reliably picking up contact lenses are known, contact lenses may be quite thin and the thickness may vary from one lens to another and, therefore, it may be difficult to reliably determine that a contact lens has been successfully picked up by the picking apparatus. Thus, there is a need for an apparatus that can reliably sense when a contact lens has been picked up, including contact lenses of different thicknesses.

### BRIEF SUMMARY OF THE INVENTION

In an exemplary embodiment of the present disclosure, a lens handler includes a first arm and a second arm, the first and second arms of the lens handler being moveable relative to each other to define an open position, a closed position, and a lens handling position. The lens handler also includes a power source electrically connected to the first and second arms and configured to pass an electrical current between the first and second arms when the arms are in the closed position.

In another exemplary embodiment of the present disclosure, a method of transporting an ophthalmic device includes transitioning a pair of arms of a lens handler from an open position to a handling position, sensing an electrical current passing between the pair of arms in the handling position, and determining whether the ophthalmic device is disposed between the arms in the handling position based on the sensed current. The method also includes transitioning the pair of arms from the handling position to the open position.

In still another exemplary embodiment of the present disclosure, a lens handler includes a first arm having a first conductive tip connected thereto and a second arm having a second conductive tip connected thereto. The first and second arms of the lens handler are moveable relative to each other to define an open position, a closed position, and a lens handling position. The lens handler also includes a power source electrically connected to the first and second tips, and a controller configured to control the relative positions of the first and second arms.

### BRIEF DESCRIPTION OF THE SEVERAL VIEWS OF THE DRAWING(S)

FIG. 1 is a partial diagrammatic illustration of an ophthalmic device forming system according to an exemplary embodiment of the present disclosure.

FIG. 2 is a perspective view of a lens handler according to an exemplary embodiment of the present disclosure.

FIG. 3 is a plan view of a portion of the lens handler illustrated in FIG. 2.

FIG. 4 is another plan view of a portion of the lens handler illustrated in FIG. 2.

### DETAILED DESCRIPTION OF THE INVENTION

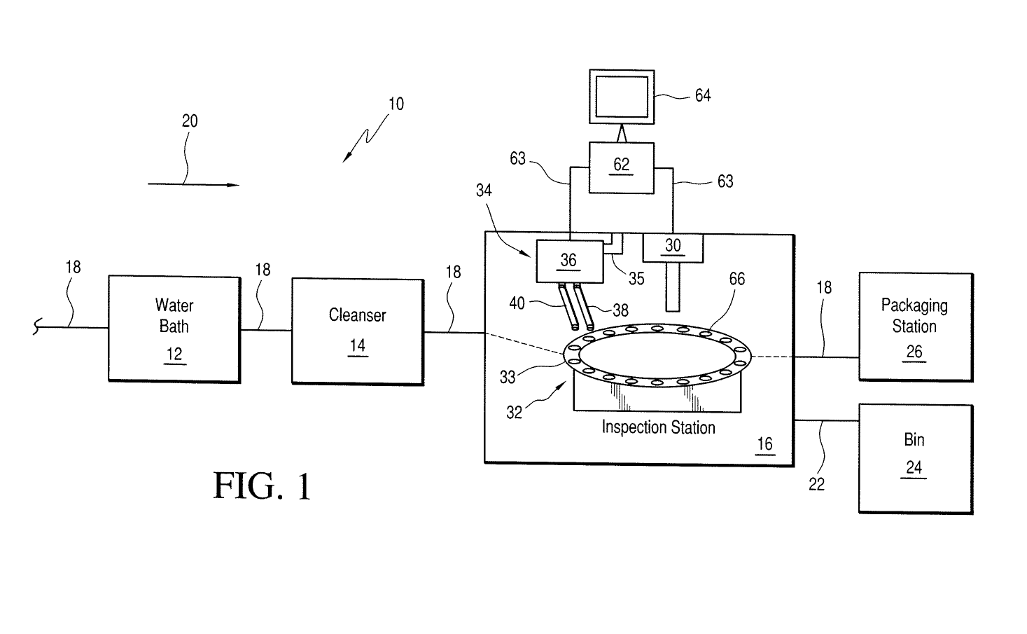

FIG. 1 illustrates an ophthalmic device forming system 10 according to an exemplary embodiment of the present disclosure. As shown in FIG. 1, the system 10 includes, for example, a water bath 12, a cleanser 14, an inspection station 16, and a packaging station 26. The water bath 12 can be connected to the cleanser 14 via a transport device 18 and the cleanser 14 can be connected to the inspection station 16 by the transport device 18. The packaging station 26 can also be connected to the inspection station 16 via the transport device 18. As shown in FIG. 1, the water bath 12 can be disposed upstream of the cleanser 14, the cleanser 14 can be disposed upstream of the inspection station 16, and the packaging station 26 can be disposed downstream of the inspection station 16. The inspection station 16 can include a lens handler 34, a sensor 30, and a carousel 32.

In forming an ophthalmic device such as, for example, a contact lens, casting molds can be dosed with a monomer, a polymer, and/or other lens forming materials. The entire casting mold assembly can then be placed into a curing apparatus where the ophthalmic device can be formed and/or otherwise cured. Once the ophthalmic device is formed it can be transported to the water bath 12 via the transport device 18. The transport device 18 can be any apparatus and/or collection of machines or devices useful in transporting items having optical quality surfaces from one machine to another machine in an assembly and/or manufacturing environment. The transport device 18 can include one or more gripping devices such as, for example, fingers, hooks, graspers, and/or any other gripping devices known in the art. Such gripping devices (not shown) can be configured to delicately grasp, secure, and/or otherwise immobilize a fragile item such as, for example, a partially formed ophthalmic device, and safely transport the fragile item from machine to machine without causing damage thereto.

Although not shown in FIG. 1, one or more carrying trays can be transported from, for example, the water bath 12 to the cleanser 14 and then to the inspection station 16 by the transport device 18. In such an exemplary embodiment, the transport device 18 can be configured to transport the carrying trays between the components of the system 10 without causing any damage to, for example, the carrying trays and/or the ophthalmic devices 56 (FIG. 4) carried thereby. The carrying trays can comprise a plurality of substantially open cells, each configured to retain an ophthalmic device 56. The substantially open cells can include at least one open section through which the ophthalmic device 56 can be relatively easily accessed.

In an exemplary embodiment, working fluid disposed within the inspection station 16 and/or fingers 42 of the lens handler 34 (FIG. 4) may access the ophthalmic device 56 via the open section. The substantially open cells can also enable the easy insertion and removal of an ophthalmic device 56 relative to the cell. Accordingly, the substantially open cells may enable the fingers 42 of the lens handler 34 to assist in removing the ophthalmic devices 56 from the carrying tray and positioning the ophthalmic devices 56 in holders 66 of the carousel 32 prior to inspection. Alternatively, as discussed above, the transport device 18 can also be configured to transport ophthalmic devices 56 individually between the components of the system 10. In such an alternative exemplary embodiment, the carrying trays can be omitted.

Referring again to FIG. 1, the water bath 12 can be any device known in the art configured to assist in fluidly removing debris, contaminants, and/or other foreign materials from an ophthalmic device such as, for example, a contact lens. Such foreign materials may be adhered to and/or otherwise carried with the ophthalmic device in an ophthalmic device forming process, and the foreign materials can be, for example, dirt, dust, and/or pieces of polymer or monomer material left over from upstream ophthalmic device forming and/or curing processes.

The cleanser 14 can be disposed adjacent to the water bath 12 and can be configured to receive ophthalmic devices 56 and/or other devices or carrying trays transported by the transport device 18. The cleanser 14 can be similar in construction to the water bath 12 and can be configured to cleanse and/or otherwise remove impurities from the ophthalmic devices 56 transported thereto. In an exemplary embodiment, the cleanser 14 can be configured to inject and/or otherwise combine a mild soap-like cleaning agent or other cleaning agent with the working fluid supplied thereto to remove impurities from the devices 56.

The inspection station 16 can be disposed adjacent to the cleanser 14, and cleaned ophthalmic devices 56, carrying trays, and/or other ophthalmic device handling components can be transported from the cleanser 14 to the inspection station 16 by the transport device 18. The inspection station 16 can be any conventional inspection station or apparatus known in the art.

As shown in FIG. 1, the carousel 32 can be mounted within and/or otherwise connected to the inspection station 16. The carousel 32 can be any known assembly and/or collection of components configured to receive a plurality of ophthalmic devices 56 and maintain the ophthalmic devices 56 in a hydrated state during inspection by one or more sensors 30. In an exemplary embodiment, the carousel 32 can be a component of a wet vision system configured to submerge and/or otherwise hydrate a plurality of ophthalmic devices 56 within a working fluid during inspection by the sensor 30. It is understood that such working fluids can include, for example, de-ionized water, F127 surfactant, and/or other like aqueous liquids.

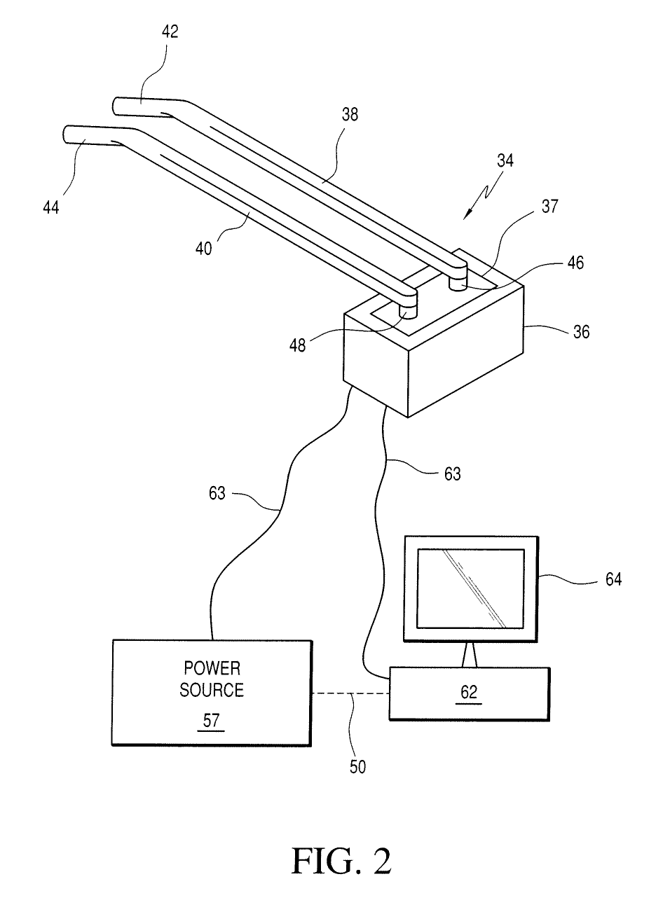

The carousel 32 can be of any shape, size and/or other configuration known in the art and can have a number of moving components configured to assist in positioning the ophthalmic devices 56 requiring inspection proximate one or more components of the inspection station 16 such as, for example, the sensor 30. In an exemplary embodiment, the carousel 32 can include a substantially circular wheel 33 (FIG. 2) configured to assist in supporting individual ophthalmic devices 56 and/or otherwise positioning the ophthalmic devices 56 proximate the sensor 30 during inspection.

In an exemplary embodiment, the wheel 33 may define a plurality of holders 66 sized, shaped, and/or otherwise configured to support and/or immobilize an ophthalmic device 56 during the inspection process. The holders 66 can be of any configuration known in the art and can be configured to immobilize an ophthalmic device 56 without causing damage to the optical surfaces of the ophthalmic device 56 disposed thereon. Each holder 66 can include, for example, a plurality of legs (not shown) or other like structures configured to assist in immobilizing the ophthalmic device 56 while the wheel 33 is, for example, rotated.

As shown in FIG. 2, the lens handler 34 can be disposed proximate, for example, the carousel 32. The lens handler 34 can be any apparatus and/or collection of machines or devices useful in safely transporting items having optical quality surfaces from one location within a machine to another location within the same machine in an assembly and/or manufacturing environment. The lens handler 34 can include, for example, a driver 36 and a plurality of arms 38,40, and at least a portion of the lens handler 34 may be connected to a translator 35 of the inspection station 16.

It is understood that components of the lens handler 34, and/or the lens handler 34 itself, can be moveable relative to the inspection station 16 and/or the carousel 32. In an exemplary embodiment, the lens handler 34 can be mounted to a mechanized component of the inspection station 16 such as, for example, a translator 35. In such an exemplary embodiment, the translator 35 may comprise a robot arm, a belt, a tray, and/or any other component configured to facilitate movement of the lens handler 34 within the inspection station 16. Such components can be driven by, for example, one or more electric motors (not shown) or other like components configured to provide motion to mechanical and/or electromechanical devices. In an exemplary embodiment, the driver 36 may be mechanically connected to such a translator 35.

The driver 36 may be coupled to at least one, and in certain configurations, to both of the arms 38,40 for moving the ends of the arms 38,40 together to pick up an ophthalmic device 56. Accordingly, at least one of the arms 38,40 may be moveable relative to the other arm. The driver 36 operating the arms 38,40 can be a hydraulic, pneumatic, electric, electromagnetic, and/or any other type of conventional actuation device known in the art. In an exemplary embodiment, the driver 36 may include a pneumatic cylinder/pump assembly capable of moving one or both arms 38,40 together to pick up a lens. Alternatively, the driver 36 may include a solenoid assembly configured to move one or both of the arms 38,40. In one configuration, one arm may be stationary and the other arm is moved so as to maximize the accuracy of the operation.

In an exemplary embodiment, the arms 38,40 and, in particular, the stems 46,48 may be connected to the driver 36 by a shock and/or vibration reducing mount 37. Such mounts 37 may include, for example, resilient elastomeric thermoplastic, thermoplastic elastomer, or thermoplastic vulcanizate materials. In an exemplary embodiment, the mounts 37 may be made of substantially nonconductive (insulative) materials.

The arms 38,40 may be configured to assist in safely transporting and/or otherwise handling an ophthalmic device 56. The arms 38,40 of the lens handler 34 can include, for example, one or more hooks, graspers, suction devices, and/or any other gripping devices known in the art. Such gripping devices can also include, for example, fingers 42,44. The arms 38,40 and/or fingers 42,44 can be configured to delicately grasp and/or handle a fragile item such as, for example, an ophthalmic device 56, and safely transport the item from a first position within a component of the system 10 to a second position within the component of the system 10. For example, the lens handler 34 can be configured such that the fingers 42,44 can remove an ophthalmic device 56 from a carrying tray and place the removed ophthalmic device 56 within the holder 66 without causing damage to the optical surfaces of the ophthalmic device 56.

The arm 38,40 and/or the fingers 42,44 may be made from metals, alloys, plastics, polymers, rubbers, and/or any combination thereof in order to facilitate the damage-free transport of such delicate items. In an exemplary embodiment, the arms 38,40 and/or the fingers 42,44 may be made from a conductive material such as aluminum, titanium, or stainless steel. In such an exemplary embodiment, the arms 38,40 and/or the fingers 42,44 may be stainless steel forceps coated and/or otherwise covered with silicone so as not to contaminate or damage the ophthalmic devices 56 handled thereby. It is also understood that the arms 38,40 and/or fingers 42,44 may comprise any known tubing such as, for example, carbon-filled silicone tubing or the like.

In an alternative exemplary embodiment, the lens handler 34 can include one or more vacuum devices (not shown). The vacuum devices can be fluidly connected to the arms 38,40 and/or fingers 42,44, and can be configured to assist in handling and/or otherwise grasping the ophthalmic devices 56 while not causing any damage to the optical surfaces of the ophthalmic devices 56 during transport.

In an exemplary embodiment, the lens handler 34 may be configured to sense and/or otherwise detect the presence of an ophthalmic device 56 disposed between the fingers 42,44. In such an exemplary embodiment, the lens handler 34 may be electrically connected to a power source 57 via one or more connection lines 63. The power source 57 may also be electrically connected to, for example, the controller 62 via a connection line 50. The power source 57 may be any conventional device configured to direct a positive and/or negative charge to automated machinery in a manufacturing and/or production environment. Power source 57 may be configured to, for example, deliver a desired voltage and/or electrical current to at least one of the fingers 42,44.

Thus, when the fingers 42,44 are in the open position illustrated in FIG. 2, substantially no electrical current may pass between the fingers 42,44, and the fingers 42,44 may define a portion of an open circuit. Similarly, when the fingers 42,44 are in the handling position illustrated in FIG. 4, the ophthalmic device 56 may act as an insulator and/or resistor in both the substantially dry and the fully hydrated state. Thus, when the fingers 42,44 are in the handling position, substantially no electrical current may pass between tips 58,60 of the fingers 42,44. Alternatively, when in the handling position of FIG. 4, a known electrical current may pass through the ophthalmic device 56 and/or other item disposed between the tips 58,60 based on the material conductivity of the item. As will be discussed below, this current can be suitably measured, and the resistance of the ophthalmic device 56 and/or other item can be calculated based thereon using known electrical circuit principles.

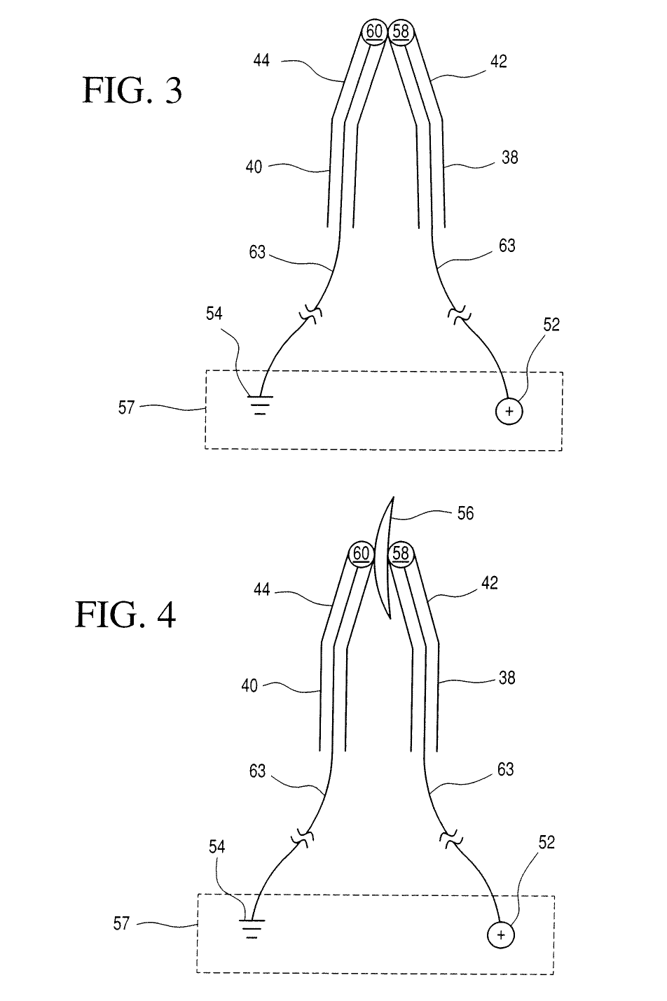

It is understood that the power source 57 discussed above with respect to FIG. 2 may comprise a positive voltage source 52 and a ground connection 54 as illustrated in FIGS. 3 and 4. It is also understood that the tip 58 may be electrically connected to one of the positive voltage source 52 and the ground connection 54, and the tip 60 may be electrically connected to the other of the positive voltage source 52 and the ground connection 54 to properly complete the electrical circuit. When no ophthalmic device 56 is disposed between the fingers 42,44, the fingers 42,44 may be brought together such that the tips 58,60 may come into contact with one another, thereby forming the closed position illustrated in FIG. 3. When the fingers 42,44 are in the closed position, the power source 57 may direct a desired voltage to the fingers 42,44 and an electrical current may pass between the tips 58,60 of the fingers 42,44 as is typical in a completed electrical circuit.

It is understood that the lens handler 34 may also comprise additional electrical components and/or circuitry capable of facilitating the detection of electrical current passing between the tips 58,60. The fingers 42,44 may act as sensors capable of detecting the presence and/or absence of an ophthalmic device 56 disposed therebetween based on simple circuit logic known in the art. As will be discussed in greater detail below, the lens handler 34 and/or the power source 57 may be configured to send input signals and/or other information to the controller 62, via the respective connection lines 63,50, indicative of the presence and/or absence of an ophthalmic device 56 between the fingers 42,44. In addition, the methods and structures disclosed herein may be configured to detect the presence and/or absence of very thin ophthalmic devices 56 such as, for example, devices 56 having a thickness between approximately 50 p and approximately 100 p, or less. Accordingly, the configuration of the fingers 42,44 of the present disclosure may enable the system 10 to instantaneously detect the presence of ophthalmic devices 56 during an ophthalmic device forming process, thereby improving cycle time. In particular, the sensitivity of the tips 58,60 may eliminate the need to pause and perform, for example, complex tip displacement readings and/or other physical displacement measurement techniques required of known lens handling devices.

Referring again to FIG. 1, the sensor 30 can be any diagnostic device such as, for example, a thermocouple, a camera, and/or a pressure sensor, configured to sense one or more characteristics of an ophthalmic device 56. In an exemplary embodiment, the sensor 30 can be a high resolution camera and/or other video, photographic, or image sensing device configured to sense, measure, and/or otherwise analyze a surface of an ophthalmic device delivered in proximity thereto. The inspection station 16 can be configured to direct and/or otherwise immerse ophthalmic devices 56 delivered thereto via the transport device 18 in a volume of working fluid. Accordingly, the sensor 30 can be configured to obtain images of the ophthalmic devices 56 in a substantially aqueous environment. It is understood that the transport device 18 can enable the ophthalmic devices 56 transported thereby to be moveable relative to the inspection station 16.

Similar to the lens handler 34, the sensor 30 can be configured and/or otherwise mounted within the inspection station 16 to be controllably and/or otherwise programably moveable relative to the transport device 18 and/or the ophthalmic devices 56 transported thereby. The sensor 30 can be mounted to tracks, motors, belts, robot arms, and/or other devices (not shown) configured to enable relative movement between the sensor 30 and ophthalmic devices 56 delivered to the inspection station 16.

The sensor 30, the lens handler 34, and/or other components of the system 10 can be electrically connected to a controller 62. The controller 62 can include, for example, an ECU, a computer, and/or any other electrical control device known in the art. The controller 62 can include one or more operator interfaces 64 such as, for example, a monitor, a keyboard, a mouse, a touch screen, and/or any other devices useful in entering, reading, storing, and/or extracting data from the devices to which the controller 62 is connected. The controller 62 can be configured to exercise one or more control algorithms and/or control the devices to which it is connected based on one or more preset programs.

The controller 62 can be connected to, for example, the sensor 30, the lens handler 34, the carousel 32, and/or other components of the system 10 via one or more connection lines 63. The connection lines 63 can consist of any conventional electrical connection means known in the art such as, for example, wires or other like connection structures, as well as wireless communication means. Through these electrical connections, the controller 62 can be configured to receive, for example, data from the sensor 30. In particular, the controller 62 can be configured to control the system 10 to accept inspected ophthalmic device for commercial sale or reject the ophthalmic devices 56 based on one or more detected impurities, lens deformations, and/or other ophthalmic device characteristics.

The transport device 18 can be configured to direct accepted ophthalmic devices 56 from the inspection station 16 to the packaging station 26 of the system 10. The packaging station 26 can be disposed downstream of the inspection station 16 and can be configured to package the accepted ophthalmic devices 56 into, for example, a blister package useful for commercial sale. The inspection station 16 can also be configured to direct the rejected ophthalmic devices 56 to a bin 24 via a transport device 22. The transport device 22 can be substantially similar in configuration to the transport device 18 and the bin 24 can be, for example, a reject bin of the system 10.

### INDUSTRIAL APPLICABILITY

The ophthalmic device forming system 10 of the present disclosure can be used with a series of other machines for the inspection and/or formation of ophthalmic devices 56 such as, for example, contact lenses. The system 10 can be configured for use with and/or otherwise included in, for example, an assembly line used to manufacture contact lenses and, in an exemplary embodiment, the system 10 can be used to inspect one or more ophthalmic devices 56 prior to packaging the devices 56 in a blister pack or other commercial sale container.

The process of moving ophthalmic devices 56 within components of the system 10 such as, for example, the inspection station 16, may be difficult for a number of reasons. For example, although it may be desirable to automate the process of moving the ophthalmic devices 56 in this way, existing automated transport equipment may not be capable of determining whether an ophthalmic device 56 has been successfully picked up with great accuracy. Reliably determining whether or not an ophthalmic device 66 has been picked up may be even more problematic if the ophthalmic device 56 is relatively thin. Making such a determination may be particularly difficult if the detection is done in real time and/or while the device used to pick up the ophthalmic device 56 is in motion. Such inaccuracies in the detection process can result in lost packaging and/or other materials due to false negative detection and/or false positive detection of the ophthalmic devices 56. Such inaccuracies can also increase the cycle time of the overall system 10.

To eliminate some of these difficulties, the system 10 may employ, for example, the lens handler 34 discussed above. The lens handler 34 may be configured to transfer wet ophthalmic devices 56 from their respective trays into the holders 66 defined by the carousel 32 of the inspection station 16 during manufacturing. The lens handler 34 can also be used at other stages of manufacturing where it is important to accurately determine whether or not an ophthalmic device 56 has been successfully picked up.

For example, ophthalmic devices 56 may be acted upon by the water bath 12 and the cleanser 14 during manufacturing. The ophthalmic devices 56 may be transported from, for example, the water bath 12 and the cleanser 14, to the inspection station 16 via the transport device 18. In particular, a plurality of ophthalmic devices 56 may be disposed on and/or within a tray (not shown), and the tray may be transported from the cleanser 14 to the inspection station 16, in the direction of arrow 20, via the transport device 18. Upon entering the inspection station 16, it may be necessary to remove each of the plurality of ophthalmic devices 56 carried by the tray and to place each of the removed ophthalmic devices 56 into a dedicated holder 66 of the carousel 32.

In an exemplary embodiment, the translators 35 may move the lens handler 34 into a position proximate the transport device 18. The controller 62 may then control the driver 36 to move one or both of the arms 38,40 to a location proximate an ophthalmic device 56 of the plurality of ophthalmic devices disposed upon the transport device 18. At this stage of the removal process, the arms 38,40 and/or the fingers 42,44 may be in the open position illustrated in FIG. 2, and the power source 57 may direct an electrical current to the tips 58,60. However, because the tips 58,60 are not in contact while in the open position, substantially no current and/or voltage may pass between the tips 58,60 of the fingers 42,44.

To remove an ophthalmic device 56 from, for example, a tray disposed upon the transport device 18, the controller 62 may control the driver 36 to close the arms 38,40 and/or fingers 42,44 upon the desired ophthalmic device 56. As shown in FIG. 4, if the tips 58,60 grasp the desired ophthalmic device 56, the arms 38,40 may define a handling position in which the ophthalmic device 56 acts as an insulator. In such an exemplary embodiment, the ophthalmic device 56 may substantially block the electrical current applied by the power source 57, thereby substantially restricting voltage from passing between the tips 58,60 of the fingers 42,44. Alternatively, a known electrical current may pass through the ophthalmic device 56 based on the level of current applied by the power source 57 and the inherent conductivity of the ophthalmic device 56. The power source 57 and/or the controller 62 may detect this blockage and/or passage of current, and software employed by, for example, the controller 62 may determine that an ophthalmic device 56 has been successfully picked up by the lens handler 34. The resistance of the ophthalmic device 56 and/or other electrical circuit properties can also be measured and/or calculated by the controller 62 based on, for example, a known voltage applied by the power source 57. It is understood that, in an exemplary embodiment, the power source 57 may transmit a signal to the controller 62 via the connection line 50 indicating that an electrical current and/or a voltage has been substantially blocked and/or restricted from passing between the tips 58,60 in the handling position. Once the controller 62 has determined that the ophthalmic device 56 has been successfully picked up, the lens handler 34 may be controlled to place the ophthalmic device 56 into an empty holder 66 of the carousel 32 for inspection by, for example, the sensor 30.

Alternatively, if the lens handler 34 fails to contact and/or otherwise remove an ophthalmic device 56 from, for example, a tray of the transport device 18, the arms 38,40 may define the closed position illustrated in FIG. 3, in which the tips 58,60 are placed into contact with one another. In such an exemplary embodiment, electrical current and/or voltage may be permitted to pass freely between the tips 58,60. In addition, the power source 57 and/or the controller 62 may detect such a transmission of electrical current and/or voltage, and software employed by the controller 62 may determine that the lens handler 34 has failed to pick up and/or otherwise remove the desired ophthalmic device 56. As discussed above with respect to FIG. 4, the power source 57 may be configured to transmit a signal to the controller 62 via a connection line 50 indicative of this passage of current and/or voltage.

It is understood that the systems and methods discussed above may enable substantially instantaneous feedback to, for example, the controller 62 and may, thus, provide the ability to substantially fully automate the process of transporting partially formed ophthalmic devices 56 within and/or between components of the system 10. In particular, the controller 62 may be programmed such that if a desired ophthalmic device 56 is disposed between the tips 58,60, the lens handler 34 will not be capable of completing and/or otherwise closing an electrical circuit. The controller 62 may then automatically acknowledge the presence of an ophthalmic device 56. In addition, if the lens handler 34 attempts to pick up an ophthalmic device 56 and the lens handler 34 is capable of completing and/or otherwise closing the electrical circuit after the attempted pickup, the controller 62 may automatically acknowledge the absence of the desired ophthalmic device 56.

It is understood that the inverse process is also true. For example, after the lens handler 34 has placed an ophthalmic device 56 into a holder 66, the lens handler 34 may be controlled to form the closed position of FIG. 3 in order to check for a closed circuit. If the lens handler 34 is capable of forming the closed circuit at this stage of the process, the controller 62 may automatically determine that the lens handler 34 delivered the ophthalmic device 56 to the holder 66 successfully. Conversely, if the lens handler 34 is not able to form the closed circuit, the controller 62 may automatically determine that the ophthalmic device 56 was not successfully released by the fingers 42,44.

While the invention has been described in connection with a presently preferred embodiment thereof, those skilled in the art will recognize that certain modifications and changes may suggest themselves to one skilled in the art. The following claims are intended to encompass those and other changes within the true spirit and scope of the invention.

1. A lens handler, comprising:
a first arm and a second arm, the first and second arms of the lens handler being moveable relative to each other to define an open position, a closed position, and a lens handling position; and
a power source electrically connected to the first and second arms and configured to pass an electrical current between the first and second arms when the arms are in the closed position.

2. The lens handler of claim 1, wherein a first finger is connected to the first arm and a second finger is connected to the second arm, the first and second fingers each defining a conductive tip.

3. The lens handler of claim 2, wherein the electrical current passes between the conductive tips of the first and second fingers when the arms are in the closed position.

4. The lens handler of claim 2, wherein the conductive tips of the first and second fingers are made from titanium.

5. The lens handler of claim 2, wherein the conductive tips of the first and second fingers are electrically connected to the power source.

6. The lens handler of claim 1, further including a driver coupled to a least one of the first and second arms and configured to assist in transitioning the arms between the open position, the closed position, and the lens handling position.

7. The lens handler of claim 1, further including a controller electrically connected to a component of the first and second arms, the controller configured to receive an input from at least one of the arms.

8. The lens handler of claim 7, wherein the input comprises at least one of a voltage measurement, a resistance measurement, and a current measurement.

9. The lens handler of claim 7, wherein the controller is electrically connected to the power source.

10. The lens handler of claim 7, wherein the controller is configured to detect the presence of an ophthalmic device substantially prohibiting the electrical current from passing between the first and second arms when the arms are in the lens handling position.

11. The lens handler of claim 1, wherein the first and second arms are mounted to a vibration-reducing mount.

12. A method of transporting an ophthalmic device, comprising:
transitioning a pair of arms of a lens handler from an open position to a handling position;
sensing an electrical current passing between the pair of arms in the handling position;
determining whether the ophthalmic device is disposed between the arms in the handling position based on the sensed current; and
transitioning the pair of arms from the handling position to the open position.

13. The method of claim 12, wherein the handling position comprises a closed position.

14. The method of claim 12, wherein the pair of arms comprises a first arm having a first conductive tip and a second arm having a second conductive tip.

15. The method of claim 14, wherein the ophthalmic device is disposed between the first and second tips when the pair of arms is in the handling position.

16. The method of claim 14, further including passing the electrical current between the first and second tips.

17. The method of claim 14, further including passing the electrical current from a power source to the first and second tips.

18. The method of claim 12, further including moving the ophthalmic device from a first component of an ophthalmic device forming system to a second component of the ophthalmic device forming system based on the determination.

19. The method of claim 12, wherein determining whether the ophthalmic device is disposed between the arms comprises comparing the sensed electrical current to a predetermined current value.

20. The method of claim 12, further including positioning the pair of arms such that the ophthalmic device is disposed between opposing tips thereof prior to transitioning the pair of arms from the open position to the handling position.

21. A lens handler, comprising:
a first arm having a first conductive tip connected thereto;
a second arm having a second conductive tip connected thereto, the first and second arms of the lens handler being moveable relative to each other to define an open position, a closed position, and a lens handling position;
a power source electrically connected to the first and second tips; and
a controller configured to control the relative positions of the first and second arms.

22. The lens handler of claim 21, wherein the controller is configured to determine whether an ophthalmic device is disposed between the first and second tips based on a sensed current value.

23. The lens handler of claim 21, further comprising a driver configured to assist in transitioning the first and second arms between the open position, the closed position, and the lens handling position.

24. The lens handler of claim 23, wherein the driver is connected to a robot arm of an ophthalmic device inspection station.

25. The lens handler of claim 21, wherein the first and second conductive tips comprise one of stainless steel and carbon-filled silicone.

26. The lens handler of claim 21, wherein the controller is configured to detect a resistance level between the first and second conductive tips.

27. The lens handler of claim 21, further including an ophthalmic device supported by the first and second tips when the arms are in the lens handling position, the ophthalmic device substantially prohibiting the passage of electrical current between the first and second tips.
